(19) United States
(12) Patent Application Publication
(10) Pub. No.: US 2002/0053400 A1
(43) Pub. Date: May 9, 2002

(54) Method for producing preforms from fiber composites as well as preform produced with this method

(76) Inventors: Torsten Lorenz, Augsburg (DE); Franz Stadler, Bohmfeld (DE); Stefan Utecht, Kaufering (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/976,265

(22) Filed: Oct. 15, 2001

(30) Foreign Application Priority Data
Oct. 13, 2000 (DE) 100 50 851.0

(51) Int. Cl. C09J 5/02

(52) U.S. Cl. 156/309.3; 156/313

(57) ABSTRACT

A method for producing preforms from fiber composite semi-finished products and polymer provides for use of the preforms as components after the curing process. Initially, on a working surface, a bonded fabric is formed by alternately placing layers of cut dry fiber composite semi-finished product sections and polymer layers with predetermined shapes on top of each other. A specified preform is formed from the bonded fabric by forming appropriate parts of this fabric and subsequently curing the parts. The polymer layers exhibit a shape that ensures bonding of cut semi-finished product sections in their overlapping areas. The polymer layers contain local recesses in order to minimize shearing stress between the semi-finished product layers in areas of the local recesses when forming the individual profile parts of the bonded fabric. A preform produced pursuant to this method results.

This application claims the priority of German application 100 50 851.0, filed Oct. 13, 2000, the disclosure of which is expressly incorporated by reference herein.

### BACKGROUND AND SUMMARY OF THE INVENTION

The present invention relates to a method for producing preforms from fiber composite semi-finished products as well as to a preform produced with such a method.

Depending on their compositions, fiber-reinforced polymers (FRP) are described as carbon-fiber reinforced plastic (CFRP), glass fiber reinforced plastic (GFRP), aramid fiber reinforced plastic (AFRP) or boron fiber reinforced polymers (BFRP). Hybrid materials (i.e. a mixture of these materials, such as CFRP tissue with AFRP rovings woven in, and so on) can be used as well. The fibrous components of these fiber composite semi-finished products, referred to as fibers in the following discussion, are formed by carbon fibers, glass fibers, aramid fibers and/or boron fibers. The components can be designed, e.g., as tissue, multi-axial bonded fabrics or unidirectional chain-reinforced semi-finished products. Suitable polymers are, for example, all epoxy prepreg polymers.

In the production of fiber reinforced polymer components, the conventional state of the art uses textile semi-finished products as the starting materials. The products are formed by at least one bonded fabric, tissue, or knitted fabric, i.e., in general, a textile flexible sheet material. The textile semi-finished products are placed in a device that represents a negative mold of the component that is supposed to be produced; these products already contain polymers, or polymers are applied to the products in the device. After a curing process, the cured material can then be removed from the device as a component.

One disadvantage of this method is that individual layers must be soaked individually with the polymer, and operators have to handle liquid materials (polymer) that are dangerous to their health. Additionally, the liquid polymer quantity that must be added, depending on the method that is used, e.g. manually with a brush or through a soaking device, can vary drastically from component to component and method to method so that a consistent quality of the respectively obtained results cannot always be guaranteed with certainty.

Furthermore, methods exist from the conventional state of the art based on which preforms are formed from several pieces and/or partial pieces of fiber composite semi-finished products before the fiber composite semi-finished product is finally treated with polymer. Preforms represent preliminary stages of the component that is supposed to be produced, while already exhibiting the shape of the latter. They can be formed for components with a geometry that can be unwound, a geometry that cannot be unwound, or a geometry that cannot be unwound completely. A component's property is described as “unwindable” or “non-unwindable” if it can or cannot be wound on a reel and then unwound again. Various methods are known for the production of such preforms.

In a so-called bonding technique, dry fiber composite semi-finished products are mixed with bonding agents, generally with bonding agents in the form of powder, and then assembled as bundles. In this composition, they are set, for example, through an appropriate warming process. Complex components are shaped manually or with the help of rubber membranes. The bonding technique has a disadvantage in that the fiber composite semi-finished products must be specially prepared and in that the material containing the bonding agents—comparable to the prepregs—must be stored in a cool place. Additionally, the bonding agents must be prepared specially and be qualified. They cannot lead to undesirable side effects with the polymers that are used later on. This is problematic, because a suitable bonding agent variation is not available for every common polymer system. In these cases, systems with bonding agents suffer with regard to their mechanical properties compared to the same fibrous material without bonding agents.

In another method, the dry fiber composite semi-finished products can be sewn together in a desired composition. All conventional sewing techniques, including tufting, crocheting or knitting, can be used. This method has a disadvantage in that complex auxiliary tools are required, especially for spatial sewing processes. The complexity of these tools requires frequent changes in the mounting process or to the device and thus increases the likelihood of defects. Additionally, the preparations required for sewing processes, and the sewing processes as such, are very labor and time intensive and therefore also cost intensive.

This invention addresses the task of making an improved method for producing preforms from fiber composite semi-finished products, as well as a preform produced with this method, available.

This task is accomplished by a method for producing preforms from fiber composite semi-finished products and polymer which can be used as components after a curing process. The method includes alternately placing layers of cut dry fiber composite semi-finished product sections and polymer layers with a predetermined shape on top of each other to initially form a bonded fabric on a working surface, forming individual profile parts of the bonded fabric, and subsequently curing the individual profile parts to form a specified preform from the bonded fabric. The polymer layers exhibit shapes that ensure bonding of inner cut semi-finished product sections as well as of cut semi-finished product sections that form outer sides of the preform facing each other in overlapping areas. The polymer layers contain local recesses in order to minimize shearing stress between the semi-finished product sections in areas of the local recesses when forming the individual profile parts of the bonded fabric. Further features are reflected in various claims set forth below.

Compared to the state of the art, the invention offers the advantage that no special preparations of the fiber composite semi-finished products with bonding agents and no sewing process with the resulting efforts are required.

Another advantage of the invention is that the raw materials, polymer layers and fibrous material are not joined until the preform is being produced. Thus, a complex storage process at cool temperatures is eliminated. The polymer quantity that is introduced is added by incorporating a certain number of layers of the polymer coating with the appropriate surface weight in g/m³ in a clearly reproducible manner. Similarly, the invention can also be applied to polymer systems that are not suited for a bonding technique, e.g. when epoxy polymer systems are used as polymer coating semi-finished products.

### BRIEF DESCRIPTION OF THE DRAWINGS

The invention is explained below based on the drawing figures.

FIG. 1 is a diagrammatic perspective illustration of a cut semi-finished product section which is to serve as a starting material for the method forming the subject matter of this invention,

FIG. 2 is a diagrammatic perspective illustration of a cut polymer coating section which is to serve as another starting material for the method,

FIG. 3 is a diagrammatic cross-sectional illustration of a bonded fabric, made of several layers of cut semi-finished product sections alternating with layers of polymer, which is arranged on a working surface so that a preform of a specified shape can be molded in subsequent procedures,

FIG. 4 is a diagrammatic cross-sectional illustration of an alternative to the bonded fabric of FIG. 3 which is positioned on a curing tool, which contains a local polymer layer recess, and in which, after an additional step on a bonded fabric such as that of FIG. 3, an area of an accordingly protruding, cut, semi-finished production section is draped on an appropriate edge surface so as to form a base of a preform,

FIG. 5a a cross-sectional illustration of a first procedural step for forming a preform with a profile that contains a reinforcement rib and, on either side of this rib, contains base layers A and B extending so as to connect a following or sub-structure, in which a bonded fabric made of layers of cut semi-finished product and polymer coating sections is positioned on a working surface,

FIG. 5b is an illustration of a bonded fabric as shown in FIG. 5a in another procedural step, in which the accordingly protruding layers have been draped to an appropriate edge so as to form the reinforcement rib of the preform, and

FIG. 5c is an illustration of a bonded fabric as shown in FIG. 5a and/or FIG. 5b in another procedural step, in which accordingly protruding layers have been draped so as to form base layers.

### DESCRIPTION OF THE PREFERRED EMBODIMENTS

The method forming the subject matter of the invention is used to produce a bonded fabric out of at least two layers of a dry fiber composite semi-finished product and at least one layer of polymer. The layers are placed on top of each other initially as separate components in such a way that the resulting bonded fabric can be used to mold a preform 1 of a specified shape in a draping process. The preform can also be a “pre-preform”, i.e. an intermediate product used to produce a preform.

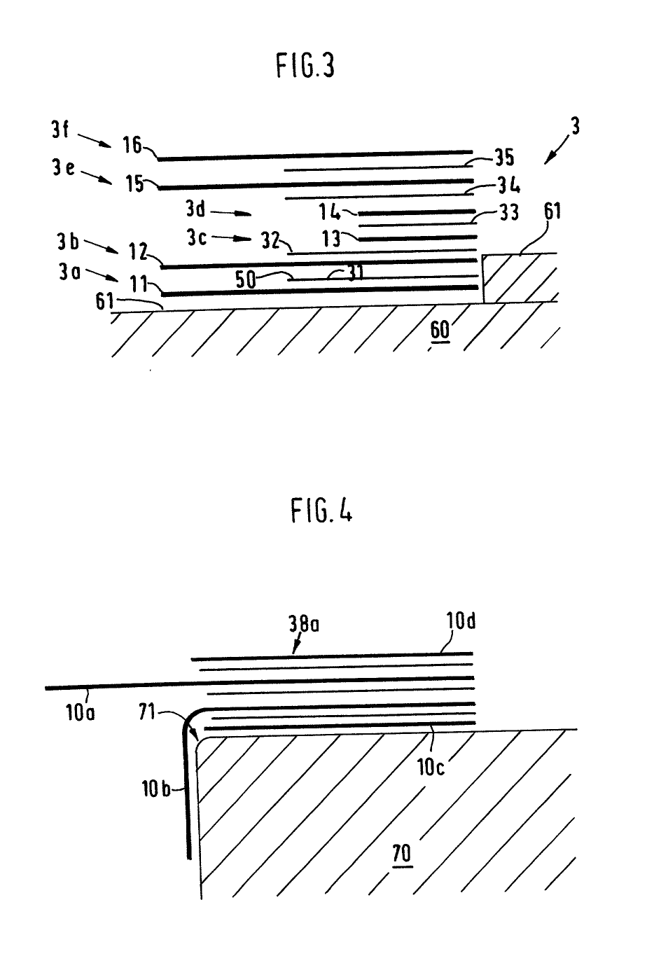

In the production method for manufacturing preforms 1 of this invention, layers of a prefabricated, dry fiber composite semi-finished product and polymer layers are placed on top of each other on a working surface 60. The polymer layers ensure the bonding of those sides of the cut semi-finished product sections that face each other in overlapping areas as long as the sides do not define any exterior sides of the subsequent preform. Thus, the polymer layers have a shape that ensures bonding of interior cut semi-finished product sections as well as of those sides of the cut semi-finished product sections forming exterior sides of the preform that face each other in the overlapping areas. The polymer layers contain local recesses in order to minimize shearing stress in the area of the local recesses when forming the individual molded parts (A, B, C, D) of the bonded fabric. FIG. 3, for example, shows such a bonded fabric, which contains the bonded fabric layers 3a, 3b, 3c, 3d, 3e, and 3f.

The preform, in general, is formed by several parts. Each of the parts usually contains a different number of semi-finished layers and/or polymer layers, resulting from the respective shape of the dry cut semi-finished product sections and the polymer layers. These parts can be arranged at an angle relative to each other. Also, protruding areas of individual bonded fabric layers can be angled by another area so as to form reinforcement segments, base layers, flanges or similar items with these protruding areas. Generally, it is necessary that the exterior sides of the individual areas be formed by the appropriate areas of the cut semi-finished product sections such that the polymer layers are located in the areas between the outer semi-finished product layers.

The polymer layers are provided for bonding the sides of the cut semi-finished product sections that face each other in overlapping side areas. In order to form the preform into a specified shape by molding the bonded fabric, which consists of the semi-finished product layers and the polymer coatings, the polymer layers are equipped with local recesses in order to enable the appropriate parts A, B, C, and D of the bonded fabric to become angled or allow the parts to move.

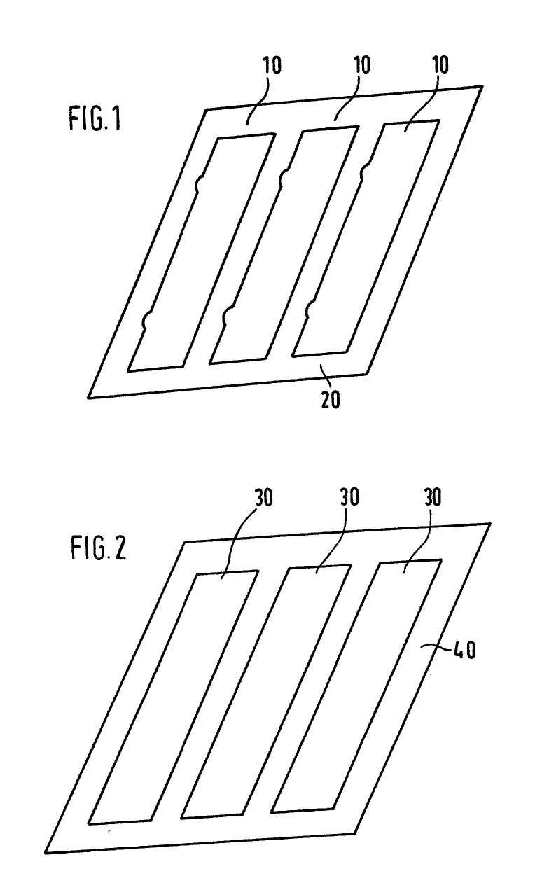

In order to form such a bonded fabric 3, according to the invention, the required cut semi-finished product sections 10 of dry fiber composite semi-finished products that do not contain polymer or adhesive are cut to size individually based on an appropriate design specification. The individual cut semi-finished product sections 10 can be cut from an unwound semi-finished product reel 20 (FIG. 1). The cutting process occurs, for example, on an even surface or a cutter table. The cut semi-finished product sections 10 can be marked initially and then be cut manually with a knife or a machine.

The polymer is provided between the semi-finished product layers so as to form the bonded fabric 3. The polymer is either introduced between the layers of cut semi-finished product sections in the form of a polymer coating when placing these section layers on top of each other or is introduced between the section layers. In another procedural step, the bonded fabric 3 is changed into the shape of the preform 1 that is supposed to be produced through a draping process. The bonded fabric 3 can be positioned on an appropriate curing tool 70, which contains suitable edges or resting surfaces in order to provide for the draping process. In the subsequent curing step, the preform 1 is cured based on the state of the art. The preform 1 can then be used to form the component that is supposed to be produced.

The polymer coating 30 can also be applied to the planned overlapping area of the semi-finished product 10 before cutting the dry semi-finished product; subsequently, the semi-finished product section 10 is cut.

According to the invention, dry cut semi-finished product sections, which are alternately stacked with the polymer layers, are used. The polymer layers are preferably formed by polymer coatings, i.e. cut polymer coating sections. The polymer is used to ensure that the individual semi-finished product layers bond with each other. If necessary, it is feasible to provide local recesses in the polymer coating for the forming process. In this way, the molding properties of the bonded fabric and/or of the preform that is supposed to be produced can be controlled specifically, because the dry fiber composite semi-finished products can shift in these areas due to the friction sliding resistance predetermined by the material.

The design specification for forming the cut semi-finished product sections, and possibly the cut polymer coating sections, is defined in such a way that, in a specific arrangement of the cut sections or the bonded fabric layers, the formation of the preform 1 that is supposed to be produced is possible and can be achieved in subsequent procedural steps.

In order to set up the preform 1 that is supposed to be produced, layers of cut semi-finished product sections 10 and polymer layers 30 are placed on top of each other in a specified thickness and shape on a preferably even working surface 60 in a specified sequence so as to form the bonded fabric 3 (see FIG. 3). The working surface 60 is preferably equipped with a separating foil 61, which can serve as a carrier for the preform. The working surface 60 is preferably equipped with a reference system or a reference device, which can be implemented, for example, through a stop 61, through a foil, or through laser pointer dots (the latter two are not shown) Additionally, the working surface 60 itself can be prepared with a polymer layer or a layer of a polymer coating in order to set the bonded fabric 3 and/or the preform 1 while it is being processed.

A first dry cut semi-finished product section 11 is initially placed on the working surface 60. A polymer layer, e.g. in the form of a cut polymer coating section 31 can be applied before this step on the top, i.e. on the side facing away from the working surface 60. It is also possible, however, to provide such a polymer layer only after the first cut semi-finished product section 11 has been positioned on the working surface 60. The first method offers an advantage in that the carrier paper and/or carrier foil 50 of the cut polymer coating section 30 stabilizes the generally very sensitive dry cut semi-finished product section 10 when placing the section on the working surface 60. Of course, this aspect is relevant any time a cut polymer coating section 30 is applied.

In order to apply a cut polymer coating section 30 onto the respective cut semi-finished product section 10, appropriate cut polymer coating sections 30 are cut from the polymer coating 40 (FIG. 2), which has been applied to at least one side of a carrier paper or a carrier foil 50, and each of the individual cut polymer coating sections 30 is positioned on at least one cut semi-finished product section 10. The cut polymer coating sections 30 can correspond completely to the shape and dimension of the cut semi-finished product sections 10. It is also possible, however, for the sections to have different shapes in order to bond only partial areas of the cut semi-finished product sections 10 with each other.

Afterwards, one side of each of the cut polymer coating sections 30, on which no carrier paper and/or no carrier foil has been arranged, is brought into contact with a respective cut semi-finished product section 10 in the appropriate position and pressed on so that the cut polymer coating sections 30 adhere to the cut semi-finished product sections 10. The sections can be pressed on, for example, with a pressure roller or a vacuum membrane (neither is shown) Alternatively, it is also possible to first apply the polymer coating 30 on the cut semi-finished product section 20 and then create the cut semi-finished product sections 10 and the cut polymer coating sections 30 at the same time in one operation.

In a first step in the example of FIG. 3, initially, a first bonded fabric layer 3a is obtained with a first cut semi-finished product section 11. The first cut semi-finished product section has a bottom side that is positioned on the working surface 60 and a top side on which a first cut polymer coating section 31 is applied. Another polymer layer 30 can be provided also on the bottom side of the first cut semi-finished product section 11. The first cut polymer coating section 31 can also have carrier paper or carrier foil 51 on its top side. The layer sequence resulting from this procedural step is, therefore, as follows when viewed from the working surface 60: working surface 60, optionally a separating foil 61 for setting the generated bonded fabric 30, a first cut semi-finished product section 11, a first cut polymer coating section 31 and a first carrier paper or carrier foil 51.

In a subsequent step, the carrier paper or carrier foil 51 is removed, and a second cut semi-finished product section 12 is applied. As with the first cut semi-finished product section 11, this section 12 may or may not already contain a second or additional cut polymer coating layer 32. In either case, the second cut polymer coating section 32 is applied to the side of the second cut semi-finished product section 12 facing away from the first cut semi-finished product section 11. Additionally, another or third cut polymer coating layer 32b can be applied to the bottom side of this cut semi-finished product section 12 (this configuration is not shown in FIG. 3). In this case, two layers of cut polymer coating sections 32, 32b are arranged in the area between the first 11 and the second 12 cut semi-finished product sections. Basically, it is also feasible to equip all layers of cut semi-finished product sections 10, 11, 12, respectively, with a cut polymer coating section 30 only on the bottom side. Finally, combinations of the described procedures are also feasible.

With this procedure, a bonded fabric 3 of a predetermined bonded fabric thickness is formed from at least one bonded fabric layer 3a, 3b, 3c, 3d, 3e, 3f. Each bonded fabric layer contains a cut semi-finished product section 10 and at least one cut polymer coating layer 30, which is arranged on the top side, i.e. in relation to the respective cut semi-finished product section on the side located opposite the working surface 60, on the bottom side, or on both sides.

According to the invention, it is only important that a cut polymer coating section 30, 31, 32 is also arranged between two cut semi-finished product sections 10, 11, 12 in the respective desired area.

The described arrangement of bonded fabric layers is continued until the desired layer thickness has been reached for the preform that is supposed to be produced. In the example of FIG. 3, the bonded fabric layers 3a, 3b, 3c, 3d, 3e, and 3f are shown. In this way, randomly graduated areas, locally raised areas, and belt layers can be generated on preforms. The result is that, for example, the structure of a preform shown in FIG. 3, consisting of cut semi-finished product sections 10 or 11, 12, 13, 14, 15, 16 and cut polymer coating sections 30 or 31, 32, 33, 34, 35, can be created.

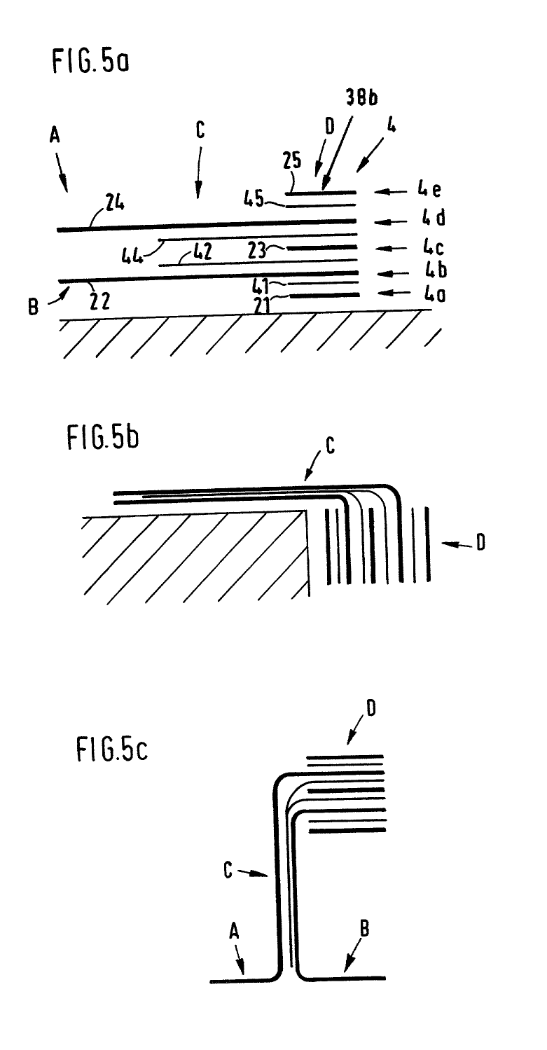

The semi-finished dry fiber composite bonded fabric that has been formed based on one or several of the above-described procedures is then transferred to a suitable curing tool 70 and formed and/or draped (FIGS. 4 and 5a-c) in stages in all necessary planes. The shape of the bonded fabric 3 and the way it is draped and formed on the curing tool 70 are planned to allow the shape of the preform that is supposed to be produced to be obtained from the bonded fabric 3. A few examples of this process are now described.

In the example shown in FIG. 4, individual cut semi-finished product sections 10a and 10b protrude from an inner stack area of cut semi-finished product sections 10 or an inner overlapping area 38a. The cut polymer coating sections 10c, 10d, however, all are smaller longitudinally extending sections that are located between these sections and the dimension of the protruding cut semi-finished product sections 10a and 10b. Thus, the free ends of the protruding cut semi-finished product sections 10a and 10b can be formed freely. This makes it possible to drape them around an accordingly provided edge 71 of the curing tool 70.

Another example of a fiber composite bonded fabric 3 with bonded fabric layers 4a, 4b, 4c, 4d, 4e and their handling in the production of a preform is shown in FIGS. 5a-5c. The bonded fabric layer 4a contains a cut semi-finished product section 21, on top of which a cut polymer coating section 41 is located. The bonded fabric layer 4b contains a cut semi-finished product section 22, on top of which a cut polymer coating section 42 is located. The bonded fabric layer 4c contains a cut semi-finished product section 23, and the bonded fabric layer 4d contains a cut polymer coating section 44, on top of which a cut semi-finished product section 24 is located. The bonded fabric layer 4e contains a cut polymer coating section 45, on top of which a cut semi-finished product section 25 is located.

The set up of the bonded fabric 3 and/or the preform P in FIGS. 5a-5c is as follows: on the working surface 60 and/or the curing tool 70, initially, a first cut semi-finished product section 21 is located. In its level dimension, the first cut semi-finished product section corresponds to the surface of an inner overlapping area 38b of the bonded fabric 4. Then, in the direction leading away from the working surface, a cut polymer coating section 21 of the same level dimension follows, as do a second cut semi-finished product section 42 that protrudes beyond the overlapping area 38b on a first side, a second cut polymer coating section 42 with a level dimension between the dimension of the overlapping area 38b and the level dimension of the second, protruding cut semi-finished product section 22, another cut semi-finished product section 23 with a level dimension corresponding to the surface of the inner overlapping area 38b, another cut polymer coating section 44 with the level dimension of the cut polymer coating section 42, a cut semi-finished product section 24 with the level dimension of the cut semi-finished product section 22, a fourth cut polymer layer section 24, and a fifth cut semi-finished product section 25 with level dimensions corresponding to the surface of the inner overlapping area 38b.

This means that parts of individual bonded fabric layers 4b, 4d, namely areas of the cut semi-finished product sections 22 and 24 and the cut polymer coating sections 42 and 44, protrude beyond an inner overlapping area 38b, as determined by the longitudinally extended area of a plurality of bonded fabric layers 4a, 4c, 4e. These layers can then form a connecting part D and a reinforcement part or rib C as well as base layers A and B. The inner overlapping area 38b, which subsequently forms a connecting part D, is determined by the bonded fabric area, which is supposed to be treated as a whole in the production of the preform. This means that its layers are not separated in subsequent steps for the production of the preform 1. In this area 38b, the semi-finished product layers 22, 23, and 24 form inner layers. The protruding areas of the cut polymer coating sections 42 and 44 are arranged between the protruding areas of the cut semi-finished product sections 22 and 24 so that they can rest against each other after being adjacent to each other (FIG. 5b) although they do not have to represent immediately adjacent layers in the starting situation. And again, those sides that do not form outer sides of the preform that is supposed to be produced are placed against each other and bonded with polymer layers.

The second and fourth cut semi-finished product sections 22 and 24, respectively, can, therefore, be bonded with each other through the second and third cut polymer coating sections 42 and 44 in a partial area, although both are immediately adjacent only to the third cut semi-finished product section 23 in the stack. On the other hand, the protruding ends of the cut polymer coating sections 42, 44 are shorter than the protruding ends of the cut semi-finished product sections 22, 24 so that the ends of the cut semi-finished product sections 22 and 24 protruding beyond the overlapping area 38b, as shown in FIG. 5c, can be further formed individually. It is possible, for example, to form, from a level bonded fabric 4, a preform with a profile where base layers A and B extend on both sides, which can be bonded with a following or sub-structure (not shown).

One of many application possibilities includes the production of non-unwindable reinforcement profiles, which are cured on a skin panel. It is also possible to use such preforms as pre-preforms and assemble them with several others into a resulting preform.

Then, in a subsequent step, the preform 1 is impregnated with additional polymer and cured. Additional polymer is injected or applied otherwise during the preform curing process. This also includes polymer based on the state of the art, e.g. epoxy, polyester, polyimide or polyamide polymers. Any random method based on the state of the art can be employed. In particular, the polymer required for this process can be applied with the so-called resin film infusion method (RFI) in the form of the above-mentioned polymer coatings. It is also possible to apply infusion techniques for the infusion of liquid polymer such as resin transfer molding (RTM) or the resin infusion (RI) method. The applicability of the respective methods depends on the compatibility of the various polymer systems that are used. If this factor is given, two or more different polymer systems can be used, wherein each epoxy resin system melts at a certain temperature. If polymer systems are used that basically have the same chemical composition, they can be mixed as well so that different polymers can be used in one component.

The polymer that is used for impregnation can be identical to the polymer that is used for the production of the preform P. However, basically, it is sufficient if both polymers are chemically compatible, i.e. if they enter into a suitable chemical reaction for the production of the fiber composite component.

The preform that is supposed to be produced can have a geometry that is completely or partially non-unwindable.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A method for producing preforms from fiber composite semi-finished products and polymer so as to use them as components after a curing process comprising:
alternately placing layers of cut dry fiber composite semi-finished product sections and polymer layers with a predetermined shape on top of each other to initially form a bonded fabric on a working surface,
forming individual profile parts of said bonded fabric and subsequently curing the individual profile parts to form a specified preform from the bonded fabric,
wherein the polymer layers exhibit shapes that ensure bonding of inner cut semi-finished product sections as well as of cut semi-finished product sections that form outer sides of the preform facing each other in overlapping areas, and
wherein the polymer layers contain local recesses in order to minimize shearing stress between the semi-finished product sections in areas of the local recesses when forming the individual profile parts of the bonded fabric.

2. The method for producing preforms according to claim 1, wherein the dry fiber composite semi-finished product includes at least one of tissue, a multi-axial bonded fabric, interlaced tissue, a mat, and a unidirectional chain-reinforced semi-finished product.

3. The method for producing preforms according to claim 1, wherein placing the polymer layers includes applying at least one of the polymer layers in the form of a polymer coating together with a carrier foil onto a first overlapping area of a cut semi-finished product section, and wherein the carrier foil is removed after pressing on the polymer coating.

4. The method for producing preforms according to claim 3, wherein the polymer coating is applied to a planned overlapping area of the semi-finished product before cutting the dry fiber composite semi-finished product, and the semi-finished product section is subsequently cut.

5. The method for producing preforms according to claim 1, wherein forming the individual profile parts creates extending base layers.

6. The method for producing preforms according to claim 1, wherein the bonded fabric is placed on a working surface, and wherein forming the individual profile parts is conducted in a curing tool.

7. The method for producing preforms according to claim 1, wherein the working surface has a separating foil as a carrier for the bonded fabric.

8. The method for producing preforms according to claim 1, wherein the working surface contains a reference device.

9. The method for producing preforms according to claim 1, wherein the working surface has a polymer layer in order to set the bonded fabric during its forming process.

10. The method for producing preforms according to claim 1, wherein the material of the polymer layers corresponds to the polymer.

11. The method for producing preforms according to claim 1, wherein the material of the polymer layer is compatible with the polymer.

12. The method for producing preforms according to claim 1, wherein at least one of the preforms is composed of a plurality of pre-preforms.

13. The method for producing preforms according to claim 2, wherein placing the polymer layers includes applying at least one of the polymer layers in the form of a polymer coating together with a carrier foil onto a first overlapping area of a cut semi-finished product section, and wherein the carrier foil is removed after pressing on the polymer coating.

14. The method for producing preforms according to claim 13, wherein the polymer coating is applied to a planned overlapping area of the semi-finished product before cutting the dry fiber composite semi-finished product, and the semi-finished product section is subsequently cut.

15. A preform produced from fiber composite semi-finished products and polymer for use as a component after a curing process made by a process comprising:
alternately placing layers of cut dry fiber composite semi-finished product sections and polymer layers with a predetermined shape on top of each other to initially form a bonded fabric on a working surface,
forming individual profile parts of said bonded fabric and subsequently curing the individual profile parts to form a specified preform from the bonded fabric,
wherein the polymer layers exhibit shapes that ensure bonding of inner cut semi-finished product sections as well as of cut semi-finished product sections that form outer sides of the preform facing each other in overlapping areas, and
wherein the polymer layers contain local recesses in order to minimize shearing stress between the semi-finished product sections in areas of the local recesses when forming the individual profile parts of the bonded fabric.

16. The preform according to claim 15, wherein the dry fiber composite semi-finished product includes at least one of tissue, a multi-axial bonded fabric, interlaced tissue, a mat, and a unidirectional chain-reinforced semi-finished product.

17. The preform according to claim 15, wherein placing the polymer layers includes applying at least one of the polymer layers in the form of a polymer coating tog ether with a carrier foil onto a first overlapping area of a cut semi-finished product section, and wherein the carrier foil is removed after pressing on the polymer coating.

18. The preform according to claim 17, wherein the polymer coating is applied to a planned overlapping area of the semi-finished product before cutting the dry fiber composite semi-finished product, and the semi-finished product section is subsequently cut.

19. The preform according to claim 15, wherein forming the individual profile parts creates extending base layers.

20. The preform according to claim 15, wherein the bonded fabric is placed on a working surface, and wherein forming the individual profile parts is conducted in a curing tool.

21. The preform according to claim 15, wherein the working surface has a separating foil as a carrier for the bonded fabric.

22. The preform according to claim 15, wherein the working surface contains a reference device.

23. The preform according to claim 15, wherein the working surface has a polymer layer in order to set the bonded fabric during its forming process.

24. The preform according to claim 15, wherein the material of the polymer layers corresponds to the polymer.

25. The preform according to claim 15, wherein the material of the polymer layer is compatible with the polymer.

26. The preform according to claim 15, wherein the preform is composed of a plurality of pre-preforms.

27. The preform according to claim 16, wherein placing the polymer layers includes applying at least one of the polymer layers in the form of a polymer coating together with a carrier foil onto a first overlapping area of a cut semi-finished product section, and wherein the carrier foil is removed after pressing on the polymer coating.

28. The preform according to claim 27, wherein the polymer coating is applied to a planned overlapping area of the semi-finished product before cutting the dry fiber composite semi-finished product, and the semi-finished product section is subsequently cut.
